(19) United States
(12) Patent Application Publication
(10) Pub. No.: US 2006/0268284 A1
(43) Pub. Date: Nov. 30, 2006

(54) Method and apparatus for surface roughness measurement

(76) Inventors: Zhiguo Zhang, Powell, OH (US); Charles E. Wickersham JR., Columbus, OH (US); Larry E. Ellison, Wellston, OH (US)

Correspondence Address: Steven Markowitz, Esq.;CABOT CORPORATION, Billerica Technical Center, 157 Concord Road, Billerica, MA, 01821-7001, US

(21) Appl. No.: 11/365,758

(22) Filed: Mar. 1, 2006

Related U.S. Application Data
(60) Provisional application No. 60/657,311, filed on Mar. 1, 2005.

(51) Int. Cl. G01B 11/30; G01B 21/30

(52) U.S. Cl. 356/600; 73/105

(57) ABSTRACT

A non-contact system and method for measuring an article surface, like a surface (or portion thereof) of a sputtering target assembly, are provided. For instance, the method includes scanning a surface with a sensing beam, and measuring the distance traveled by the sensing beam reflected from the surface, to a sensing device. The system can include a sensing device for collecting surface data at a plurality of points on the surface, and an analyzing device for analyzing the collected data.

This application claims the benefit under 35 U.S.C. §119(e) of prior U.S. Provisional Patent Application No. 60/657,311 filed Mar. 1, 2005, which is incorporated in its entirety by reference herein.

### FIELD OF THE INVENTION

The present invention relates to a non-contact method and apparatus for measuring the surface roughness of work pieces or articles, such as non-metallic or metal articles like sputtering targets and coils. The surfaces measured can be a sputter surface, an o-ring surface, a grit blasted surface, and/or the arc sprayed surface or other surfaces. The present invention also relates to the automatic measurement of surface roughness.

### BACKGROUND

Cathodic sputtering is the controlled dislodging and transferring of a material from a target to a substrate. The process includes providing a cathode which is the sputtering target or targets, and an anode which is normally a vacuum chamber filled with an inert gas. The sputtering process further includes applying a high voltage electric field and a magnetic field, across the sputtering target and the anode.

Sputtering target surface texture can be an important factor that influences the semiconductor industry. It is a factor that affects the function and reliability of the chip manufacturing process and the quality of the produced chip. Many chip defects are caused by unsatisfactory target conditions, including inclusions, poor surface finish, and contamination. These factors can cause arc in the plasma, which in turn can reduce production yield (e.g., chip yield). In view of the foregoing, there exists a great need for a method and device for measuring target surface texture (e.g., surface roughness), in order to provide improved quality control. Improved quality control ensures the provision of sputtering targets having improved surface texture, which in turn provides a more stable film deposition rate, a more uniform film, and a process requiring less burn-in time.

Both planar and hollow sputtering targets have a very narrow o-ring. As can be seen in FIGS. 1 and 2, this narrow dimension does not permit the use of a stylus profiler for measuring surface texture. Because the o-ring is an element that is critical to ensuring proper sealing and plasma generation, it is important to provide a method and apparatus for measuring the surface texture of this element. Further, the stylus surface profiler leaves marks on the target metal surface, especially when the surface comprises soft metals including tantalum. These marks are cosmetically undesirable and increase the burn-in time. In addition, if such stylus marks are present on the arc spray or grit blast area, they can negatively influence the performance of the sputtering target.

Production efficacy and quality control demand an automated process. Accordingly, the provision of a fully automated, non-contact method and device for measuring sputtering target surface roughness, is vital.

### SUMMARY

It is therefore a feature of the present invention to provide a non-contact method and system for measuring surface texture or surface roughness of work pieces or articles, like sputtering target assemblies (e.g., sputter target with backing plate) or components thereof.

A further feature of the present invention is to provide a non-contact method and system for measuring surface texture or surface roughness of planar sputtering targets or hollow sputtering targets, such as hollow cathode magnetron (HCM) targets.

A further feature of the present invention is to provide a sensor-mediated, non-contact method and system for measuring surface texture or surface roughness.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a non-contact method and system for measuring surface texture or roughness. A non-contact system for measuring surface roughness can include a non-contact sensing device, movably disposed above a surface of an article, for collecting surface data at a plurality of points on the surface; and an analyzing device for analyzing the collected data. A non-contact method for measuring surface roughness can include measuring the distance traveled by a sensing beam reflected from one or more points on a surface of an article.

It is to be understood that both the foregoing general description and the following detailed description are exemplary and explanatory only and are intended to provide a further explanation of the present invention, as claimed. The accompanying drawings, which are incorporated in and constitute a part of the application, illustrate various aspects of the present invention and together with the description, serve to explain the principles of the present invention.

### BRIEF DESCRIPTION OF THE DRAWINGS

Various embodiments of the present teachings are exemplified in the accompanying drawings. The teachings are not limited to the embodiments depicted in the drawings, and include similar structures and methods as set forth in the following description and as would be known to those of ordinary skill in the art in view of the present teachings. In the drawings:

FIG. 1 is a cross-section view of a planar sputtering target.

FIG. 2 is a cross-section view of a hollow cathode sputtering target.

FIG. 3 is a schematic view of an embodiment of the present non-contact system for measuring surface texture

FIG. 4 is a perspective view of an embodiment of the present non-contact system for measuring surface texture.

FIG. 5 is graph of surface texture data for one example.

FIG. 6 is graph of the surface texture data of FIG. 5 and includes the reference line.

FIG. 7 is a graph of the data shown in FIG. 5 where the data corresponding to the reference line shown in FIG. 6 has been subtracted out.

FIG. 8 is a graph of the sputter surface texture, of a measured sputtering target.

FIG. 9 is a graph of the o-ring surface texture, of a measured sputtering target.

FIG. 10 is a graph of the arc spray/grist blast surface texture, of a measured sputtering target.

FIG. 11 is a graph illustrating the comparison between an embodiment of the present non-contact, optical, method for measuring sputtering target surface texture, and a method for measuring sputtering target surface texture using the POCKET SURF surface profiler.

### DESCRIPTION OF VARIOUS EMBODIMENTS

The present invention provides a non-contact method and system for measuring surface texture (e.g., surface roughness). The system and method can be automated or semi-automated. The system and method can be integrated into a production line for workpieces or articles in order to measure and monitor the surface texture during production. Article production can be automatically adapted based on monitoring results.

In at least one embodiment, the present invention relates to a non-contact method for measuring surface roughness that can include scanning a surface of an article or workpiece at one or more points, with a sensing beam emitted from a sensing device, and measuring the distance traveled by the beam reflected from each contact point on the surface, to the sensing device, to generate data. The scanning can include sequentially scanning the surface at a plurality of points, wherein the distance traveled by the beam reflected from the surface to the sensing device, is measured for each contact point. The sequentially scanning at a plurality of points can include sequentially scanning at least two points, from two to 10,000 data points, or any number of points. During sequentially scanning, the sensor can optionally stop for any amount of time between each contact point. The sensing beam can be automatically focused at each contact point.

Various methods of the present invention can further include analyzing the data generated. In the present invention, the non-contact, method, and system for measuring surface roughness can have the data that is generated adjusted to correct for error. The error can include system error(s), waviness, and the like. In the present invention, the method can include digitizing the surface. The surface analyzed can, for instance, include one or more of a sputter surface, an o-ring surface, and an arc sprayed or grit blasted surface, and the like.

The present invention can be fully automated. For instance, one or more of roughness measurements, data acquisition, and data processing can be automated.

In at least one embodiment, the present invention relates to a non-contact, optical method and system for measuring surface roughness. The focal point can vary with the wavelength of the emitted optical beam. The present invention also relates to a non-contact, laser method and system for measuring surface roughness.

In the present invention, multiple measurements of the surface can be taken. The present invention can include monitoring the surface roughness, such as during manufacturing or prior to or after manufacturing.

The present invention also relates to an automated, non-contact system for measuring surface roughness, that is integrated into a production line of manufacturing work pieces or articles, like sputtering targets, in order to monitor the surface roughness during production. One specific example is monitoring roughness of one or more of the surfaces, such as the sputter target surface, the o-ring surface, and/or the arc spray/grit blast surface. This can be done before, during, and/or after the sputtering target production. The surface roughness can be determined more than once and/or at different points during production, in order to facilitate trouble-shooting during production. The acquired data is sent directly to a database for process control.

The non-contact system for measuring surface roughness can include a non-contact sensing device(s), movably disposed above a surface, for collecting surface data at a plurality of points on the surface; and an analyzing device(s) for analyzing the collected data. The present invention can also provide a non-contact system for measuring surface roughness, including an article, an article support means, sensing means, means for moving the sensor, means for controlling motion, means for acquiring data, and means for analyzing and processing data.

The present invention includes a method for calibrating the present systems, including measuring the surface at a plurality of points on the article surface, using the present system to generate data, and measuring the surface at those same plurality of points using a stylus surface profiler to generate stylus data, and comparing the stylus data and the data.

For purposes of the present invention, the term “non-contact” means that no physical component contacts the sputtering target surface. Rather, the sputtering target surface is scanned with a sensor beam. For the purposes of the present invention, the term “periodically determining” means determining one or more times, determining at least twice, determining two to four times, determining from two to six times, or determining three to ten times. For the purposes of the present invention, the term “plurality” means “two or more.”

Surface texture can be understood as the repetitive or random deviation from the normal surface. It includes waviness, roughness, lays, and flaws. Waviness is the more widely spaced component of surface texture, and it shows the global shape of the surface. Surface roughness is the finer random irregularities of the surface, which are within the limits of the sampling length. For purposes of the present invention, surface texture and surface roughness are used interchangeably. As stated herein, essentially, surface texture or surface roughness is intended to simply be a determination of the deviation from a normal (e.g., flat) surface.

In the present invention, a sensor is preferably used to measure surface roughness. For example, an optical sensor is used to digitize the surface texture. The sensor can measure a 10 nm (or less) change in height. Other changes more sensitive to changes in height, like a 5 mm change or less, can be used. The step change of the motor can be about 0.02 mm or more, which is the digitized “frequency.”

Suitable non-contact sensing devices include optical sensors that emit light or other energy and measure the distance of light reflected from the surface to the sensor, where the focal point varies with the wavelength of the light; and laser sensors that emit a laser beam and measure the distance of the beam reflected from the surface to the sensor; and ultrasonic sensors that emit a sound wave and measure the distance of the sound wave reflected from the surface to the sensor. Suitable non-contact sensing devices can be selected and employed by the skilled artisan without undue experimentation, based on the guidelines herein including the article surface, the resolution or sensitivity desired (ability to detect a minimum height change on the surface), and the like.

For purposes of the present invention, any surface, whether metallic or non-metallic, can benefit from the present invention. Any surface that is capable of having a surface texture or surface roughness can be measured by the present invention. Thus, the present invention has the ability to measure surfaces, such as metallic surfaces, natural surfaces (e.g., stone), polymeric surfaces, and the like. The workpiece or metal article having a surface that can be measured for surface texture or surface roughness can be any type of article or shape, such as a plate, container, or other geometric shape. Examples include metal articles, such as metal plates, sputter targets, sputter target assemblies, coils, such as RF coils, and the like. For purposes of the present invention, the term “sputtering target” is used and is meant to include the overall sputtering target assembly, which includes the sputter target attached onto a backing plate or a hollow cathode magnetron target or can include components thereof, such as the backing plate alone, the sputter target alone, or other components used to perform sputtering. Essentially, the sputtering target or assembly thereof can include any physical vapor deposition target or any surface that is capable of being sputtered. For the preferred embodiment, the sputtering target can comprise a metallic sputtering target. The sputtering target can include, a target blank, a target not bonded or otherwise attached to a backing plate, or a target bonded or otherwise attached to a backing plate. The sputter target can comprise a hollow cathode magnetron (HCM) target, a planar target, or any other shape target. The target can comprise any shape, including for example, a disk-shape, a conical shape, a cylindrical shape, or a pyramidal shape. The target can be solid or hollow. The target can include an O-ring seat area. The target can include a grit blast area and/or arc or other coated spray. The metallic sputtering target can comprise, for example, one or more metals selected from a FCC metal, a BCC metal, or other metals. Specific metals can include tantalum, niobium, titanium, tungsten, copper, cobalt, gold, aluminum, and one or more alloys thereof.

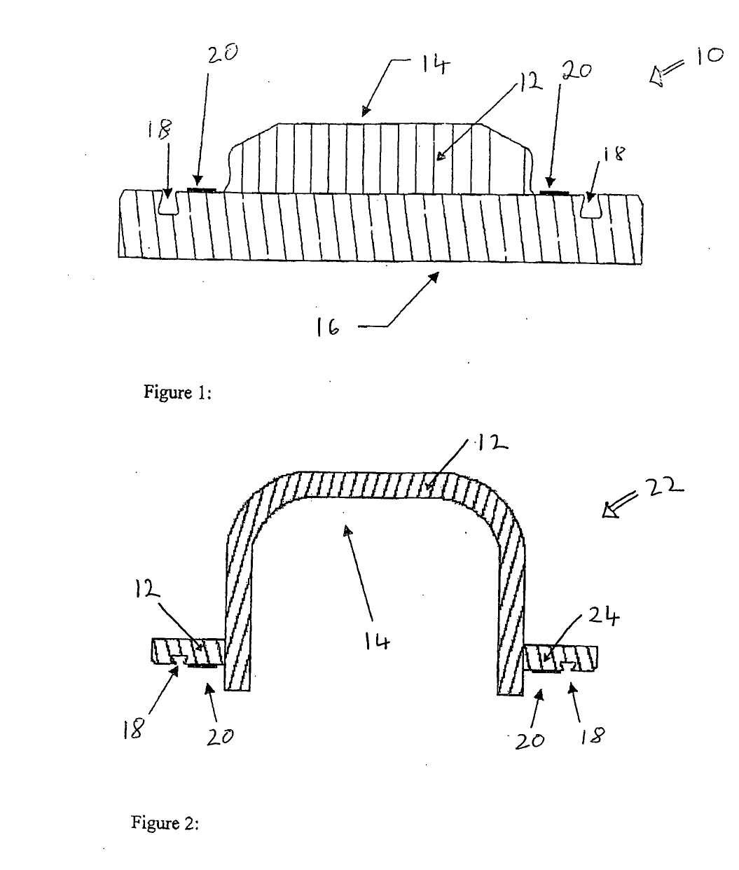

Turning to the Figures, FIG. 1 illustrates a cross-section view of a planar sputtering target assembly (10) including target material (or the actual material to be sputtered) (12) having a sputter surface (14). The target material (12) is attached to backing plate (16) having an annular O-ring seat surface (18) and a grit blasted area and/or arc sprayed surface (20). The sputtering target surface can include one or more of the sputter surface (14), the O-ring seat surface (18), and the grit blasted area and/or arc sprayed surface (20). It is to be understood for purposes of the present invention that any surface or portion thereof can be measured by the present invention. The amount of surface area to be measured or examined can be any amount of surface area. The surface of the workpiece article can be measured entirely at one time, regions of the workpiece or article can be measured sequentially region by region. While the preferred example is a sputtering target assembly which is discussed below, it is to be understood that the system and method of the present invention can equally apply to any other surfaces that have surface texture and/or surface roughness.

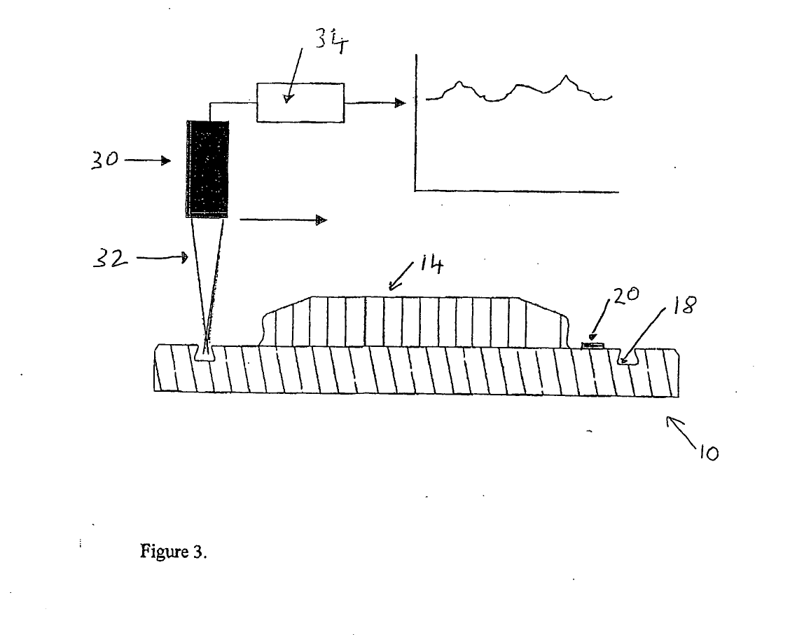

FIG. 2 illustrates a cross-section view of a hollow cathode sputtering target (22) including cylinder-shaped or container shaped target material (12) having sputter surface (14). The cylinder-shaped target material (12) includes an annular flange (24) disposed along the outer edge of its open end. The annular flange (24) includes an annular O-ring seat surface (18) and a grit blasted and/or arc sprayed surface (20).

FIG. 3 illustrates a view of an embodiment of the present system including planar sputtering target assembly (10) including sputter surface (14), O-ring surface (18), and grit blasted and/or arc sprayed surface (20). A sensor (30) emits a sensing beam (32). The beam strikes the target surface and is reflected back to the sensor (30). The sensor (30) collects surface data based on the traveling time of the beam (32) from the sputter surface (14), O-ring surface (18), or the grit blasted and/or arc sprayed surface (20), or any other surface to the sensor. For instance, the sensing beam can be an optical beam (32), and the focal point can vary with the wavelength, and can be adjusted accordingly. The distance between the target surface and the sensor is sent to a computer by the data acquisition means (34). The sensor (30) can move across the target surface to scan the desired portions or all of the surface, measuring the distance from a reflected beam to the sensor (30) at a plurality of points on the target surface. The sensor (30) sequentially contacts the target surface to measure the distance at each point, where the plurality of points includes any number of points, such as at least two points, at least 20 points, at least 25 points, at least 100 points, at least 200 points, from two to about 10,000 points, from about 200 to about 10,000 points, from about 500 to about 7,500 points, from about 1,000 to about 5,000, from about 1,500 to about 2,500, or about 2,000 points. Any number of points can be measured based on the desired detail of the results. There is no limit on the number of points that can be measured. The sensor can stop between measurements, for a discrete period of time, in order to eliminate vibration. The period of time can be any amount of time and preferably is the minimum amount of time to substantially, if not entirely, eliminate vibrations. Suitable stop time periods can include, but are not limited to, from about 20 milliseconds to about one second, from about 50 milliseconds to about 750 milliseconds, from about 100 milliseconds to about 500 milliseconds, from about 150 milliseconds to about 300 milliseconds, or for about 200 milliseconds.

The surface texture can be calculated from the distance data. The sensor (30), for example, can be an optical sensor or other sensor that emits an optical beam and measures reflected light, or a laser sensor that emits a laser beam and measures the reflected beam. Essentially, any device can be used that emits a beam of some sort which can be measured, such as by a reflection.

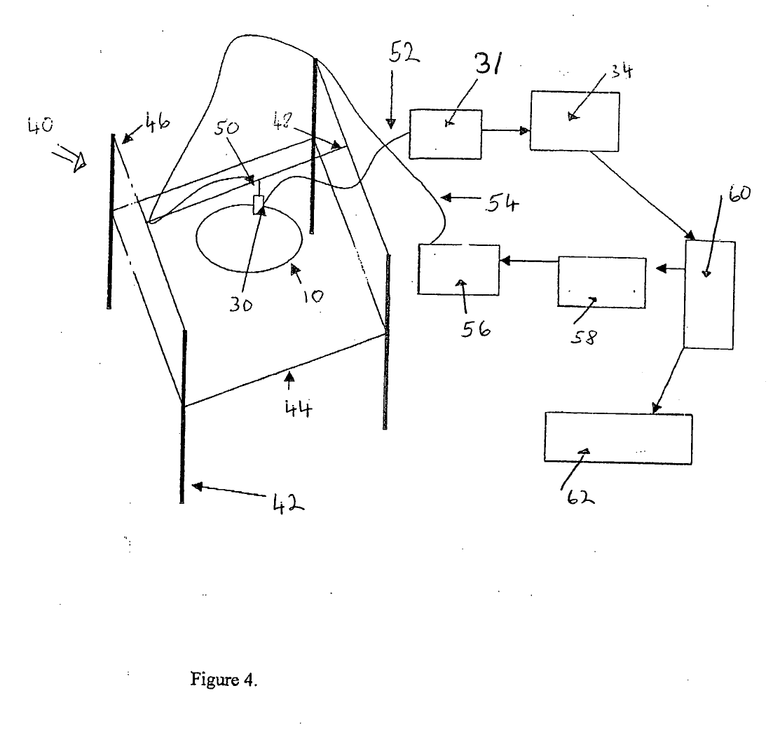

FIG. 4 illustrates a perspective view of an embodiment of the present system including support device (40) which includes frame (42), and plate (44), which together define an x (46) axis, a y (48) axis, and a z (50) axis. The plate (44) can comprise any material sufficient to support an article like sputtering target and preferably ensure that the sputtering target or other article is not scratched. Suitable plate materials include plastics, including for example, polypropylene, metal, natural surfaces, and the like. Any surface can be used and preferably the surface will not scratch or otherwise affect the surface of the article or workpiece being measured. In this example, the plate (44) supports sputtering target (10). Sensor (30) is disposed above sputtering target assembly (10). Sensor (30) is connected to a sensor box (31), which can control the optical sensor with respect to its various functions, such as scanning functions. An example of a sensor box is a CHR150 available from MicroPhotonics, which is connected to a sensor cable (52), including for example, and optical fiber cable (52). The motion drive (56), for example, nuDrive available from National Instruments, is connected to a motion controller (58), for example, National Instruments PCI 7344, available from National Instruments. The optical fiber cable (52) emits a beam of light that strikes the target surface and is reflected back. The optical sensor (30) collects surface data based on the focal point of the reflected beam. The collected data travels to the data acquisition device (34). The data acquisition device can be, for example, a DAQ device, including for example, a National Instruments 6023E card. The x axis (46) and the y axis (48) are used to move the sensor (30), via the motion control cable (54) controlled by the motion controller (58) and the motion drive (56). The z axis (50) is used to automatically adjust the focus of the optical sensor (30) which can also adjust the wave length. The sensor (30) can be moved in any direction or at any angle necessary to accommodate measuring surface texture of a workpiece or article having a particular shape. The data acquired by the optical sensor (30) can be sent to the data acquisition device (34) through optical fiber cable (52). The data travels from the data acquisition device (34) to the data processing device (60) which can include, for example, a computer, including for example, a PC. The data processing device (60) processes the data, and controls the motion of the sensor (30) via the motion controller (58), the motion drive (56) and the motion control cable (54). The processed data can be outputted (62) to an appropriate format, including for example, a spread sheet format. The surface texture is calculated from the distance data.

Regarding the optical sensor (30), suitable sensors include, for example, a 1 mm, 3 mm, 10 mm, 85 μm, or a 350 μm optical sensor. Any type of sensor can be used. The size of the optical sensor can be selected based on the surface requirements. For example, if the surface finish is less than 250 nm, a 350 μm sensor can be used, otherwise, a 10 mm optical sensor can be used.

A suitable sensor, such as an optical sensor or a laser sensor can be readily selected and employed by the skilled artisan based on the guidelines described herein, including the surface being measured, the particular sensor desired, and the resolution (for example, the minimum change in height, the sensor needs to measure) desired, without undue experimentation.

The control system can be programmed using any suitable programming instrument, including for example, National Instruments Labview 7.0, available from National Instruments. Likewise, the data can be processed and analyzed using any suitable means, including for example, Mathworks Matlab R14, available from The MathWorks, Inc., Natick, Mass.

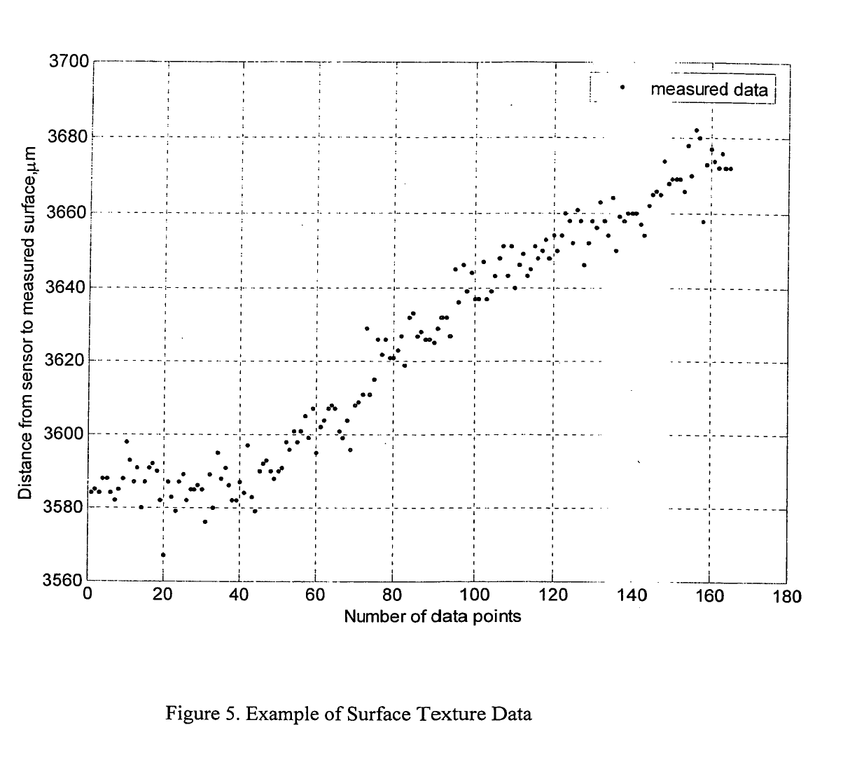

FIG. 5 illustrates a graph of data collected using an embodiment of a method and system of the present invention where the sensor was a 10 mm optical sensor and the sensor box was a CHR 150, available from MicroPhotonics, Irvine, Calif. The surface of the article measured was a tantalum sputter target attached to a copper alloy backing plate having an O-ring and a grit blasted/arc sprayed surface. The optical sensor was used to digitize the surface texture. In this example, the optical sensor measured a 10 nm or more change in height. The step change of the motor was 0.02 mm, which was the digitized frequency. The measuring steps can be any distance, such as 0.01 mm or less to 10 mm. The number of data points was plotted along the x axis, and the distance of the beam reflected from the surface to the sensor was plotted along the y axis. The measured data was indicated by dots, i.e., “•,” while the reference values were indicated by the illustrated reference line or mean line.

In this example, in order to ensure the accuracy of the data, the optical sensor was stopped for 200 miliseconds between each measurement point in order to eliminate vibration. Further the intensity of the sensor reading was strictly controlled by controlling or maintaining optical focusing. The sensor automatically focused during the beginning of measurement for each data point, for instance, based on the intensity reading.

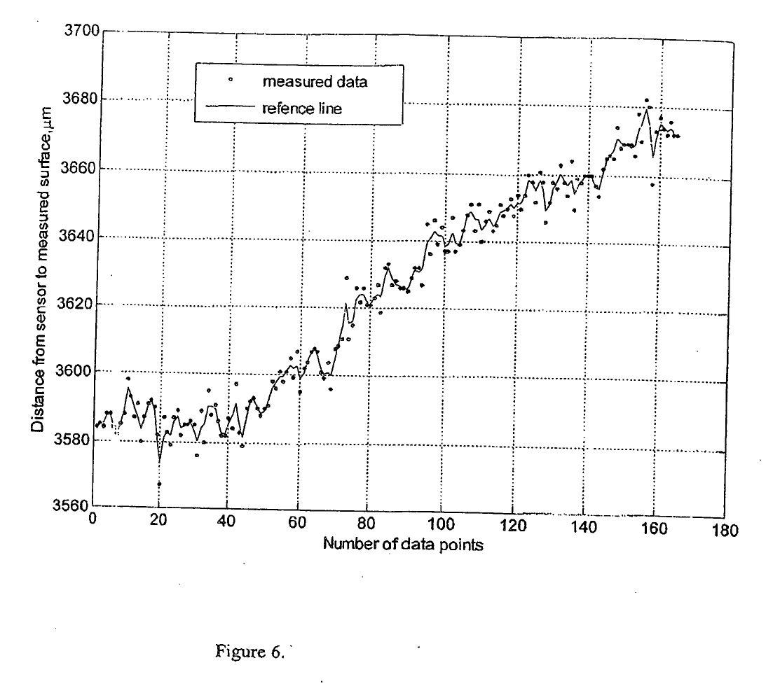

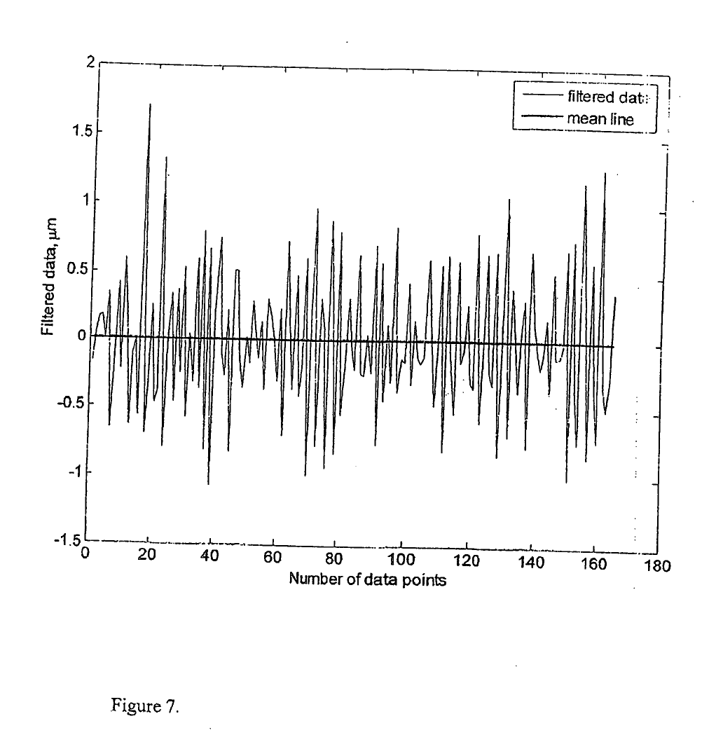

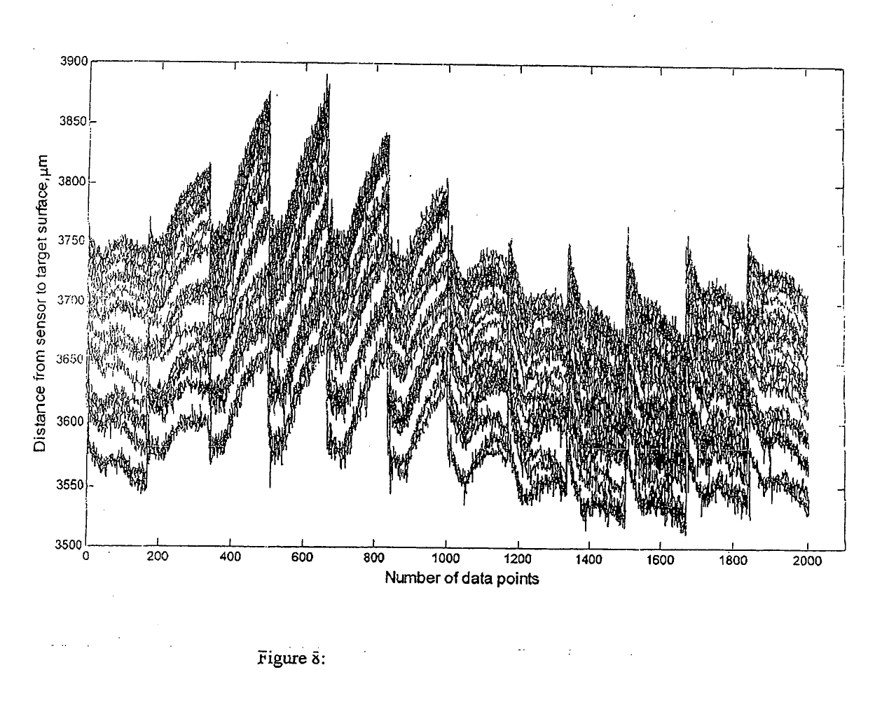

A reference line or mean line was calculated and subtracted from the generated data in order to remove system error. System error can be caused by difficulty maintaining the sensor at the same level, difficulty ensuring that the table supporting the target is level, and difficulty machining the table including an x-axis, a y-axis, and a z-axis given that the table is designed to be large enough to hold, for example, a target assembly having a diameter of 300 mm. The larger the table, the more difficult it is to make the table perfectly level. In view of the foregoing, system error can exist. Based on the repeatability of the system error, a reference line was developed to remove any error, for instance, by drawing a line (such as determining the mean of the dots). From the data shown in FIG. 5, a reference was calculated in order to remove the waviness of the surface and to remove system error. The reference line is indicated by the line appearing in the graph of FIG. 6. As shown in FIGS. 5 and 6, there is a slope which steadily increases from the left of the graph to the right of the graph. This upward slope is indicative of a workpiece or article not being completely level on the measuring surface. In the present invention, there is no need to spend great amounts of time to level the article surface since this error can easily be addressed at a later point. In particular, FIG. 7, which is further discussed below, is a representation of the non-level surface being adjusted due to this error. FIG. 7 shows a flat line from left to right of the data points which has been adjusted for the lack of levelness of the measured surface.

FIG. 7 illustrates a graph of the data of FIGS. 5 and 6, illustrating surface roughness only, with error due to non-levelness, waviness and system error, removed. Specifically, the final values (filtered data), where the reference values have been subtracted from the original data values, are illustrated. The number of data points is plotted along the x axis, and the filtered data (final value=original value-reference value) is plotted along the y axis. The line at “0” along the x axis, is the mean line.

The surface roughness calculation is based on the final value. For example, the most common amplitude measurement Ra is calculated as follows:

$${R}_{a} = \frac{1}{n} {\int }_{i = 0}^{i = n} \vert {X}_{i} \vert ⅆ x$$

where Xi is the deviation from the reference line or “mean” line in FIG. 7. In the example, the data shown in FIGS. 5, 6, and 7, has an Ra equal to about 400 nm, based on this calculation.

In order to calibrate the present system, e.g., the optical surface profiler, two steps can be performed. First, about 25 surface roughness measurements are taken using the present system. Any number of surface roughness measurements can be taken to calibrate the present system. There is absolutely no limit on the number of measurements. The data is shown in FIGS. 8, 9, and 10. The optical profiler takes a measurement, for example, at every other 30-degree interval. The second step can include checking each measurement, for instance, using a surface profiler, POCKET SURF available from Mahr Federal of Providence, R.I. Again, the calibration is simply an optional step in the present invention which can be done, especially for quality control purposes.

FIG. 8 illustrates a graph of the statistical measurement data collected for the O-ring surface (18), where the number of data points is plotted along the x axis, and the distance from the reflected beam from the target surface to the optical sensor in μm, is plotted along the y axis.

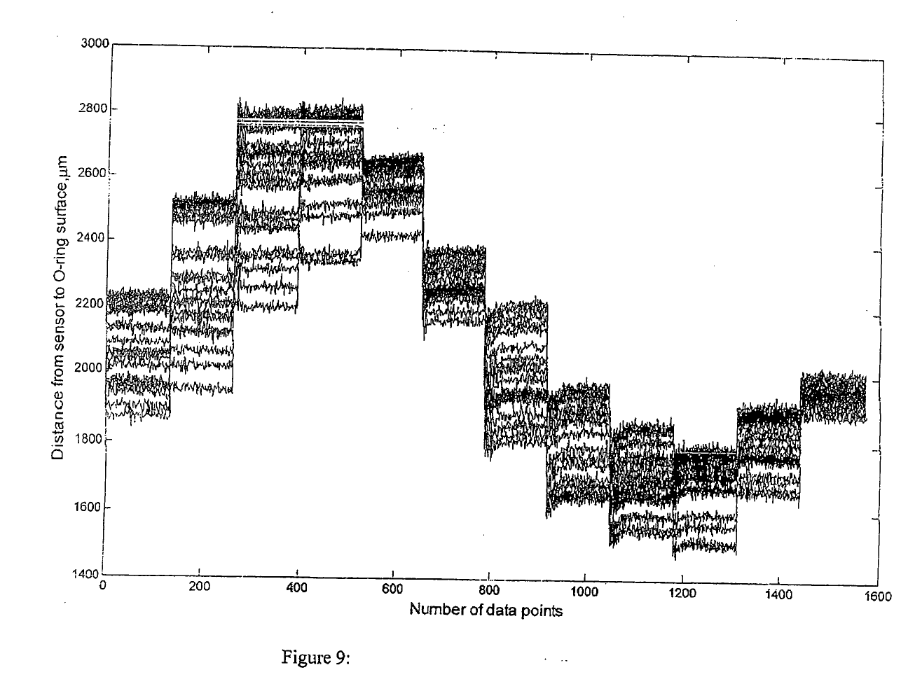

FIG. 9 illustrates a graph of the statistical measurement data collected for the sputter surface (14), where the number of data points is plotted along the x axis, and the distance from the reflected beam from the target surface to the optical sensor in μm, is plotted along the y axis.

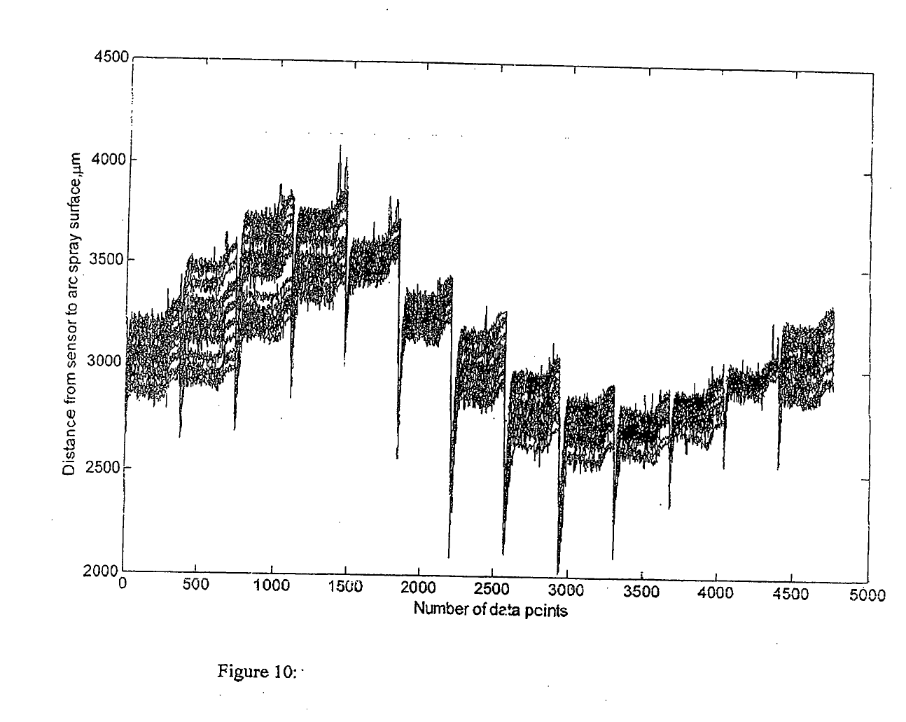

FIG. 10 illustrates a graph of the statistical measurement data collected for the arc spray surface (20), where the number of data points is plotted along the x axis, and the distance from the reflected beam from the target surface to the optical sensor in μm, is plotted along the y axis.

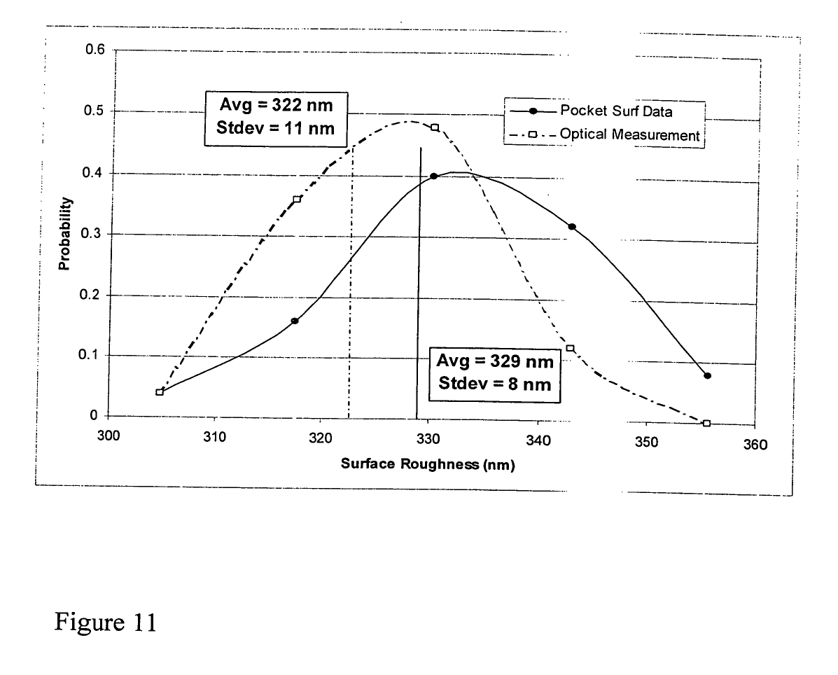

FIG. 11 illustrates a comparison between data generated using an embodiment of the present optical surface profiler system, and data generated using the POCKET SURF surface profiler.

It will be appreciated that the non-contact method and system for measuring sputtering target texture is equally applicable to surfaces of all types. All such modifications are intended to be within the scope of the present invention.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A non-contact system for measuring surface roughness of an article, comprising:
a non-contact sensing device, movably disposed above a surface of an article, for collecting surface data at a plurality of points on the surface; and
an analyzing device for analyzing the collected data.

2. The system of claim 1, further comprising:
a data acquisition device for acquiring the data from the sensing device.

3. The system of claim 1, wherein the analyzing device comprises a computer.

4. The system of claim 2, wherein the sensing device comprises at least one optical sensor.

5. The system of claim 2, wherein the sensing device comprises at least one laser sensor.

6. The system of claim 4, wherein for each data point, the optical sensor measures the distance traveled by a beam of light reflected from a point on the surface, to the optical sensor.

7. The system of claim 5, wherein for each data point, the laser sensor measures the distance traveled by a laser beam reflected from a point on the surface, to the laser sensor.

8. The system of claim 6, wherein the optical sensor and the data acquisition device are adapted to continuously acquire data at a plurality of points on the surface.

9. The system of claim 1, wherein the system is fully automated.

10. A production system for manufacturing sputtering target assemblies, comprising:
the non-contact system of claim 1.

11. The non-contact system of claim 1, wherein said article is a sputtering target assembly or a RF coil.

12. The non-contact system of claim 1, wherein said article is a sputtering target assembly and said surface is a sputter target surface, backing plate surface, grit blasted surface, arc sprayed surface, portions thereof, or combinations thereof.

13. A non-contact method for measuring surface roughness, comprising:
measuring the distance traveled by a sensing beam reflected from one or more points on a surface of an article, and further comprising:
sequentially measuring at a plurality of points, the distance traveled by the beam reflected from the surface, wherein the measuring is optionally temporarily stopped between each measurement, and wherein the measuring is optionally automated, and optionally, further comprising analyzing data generated to determine the surface roughness.

14. The method of claim 13, wherein an optical sensor is utilized to receive the beam that is reflected and the sensing beam comprises light.

15. The method of claim 13, wherein a laser sensor is utilized to receive the beam that is reflected and the sensing beam comprises a laser beam.

16. The method of claim 13, wherein the sequentially measuring includes digitizing the surface, and wherein the sensing beam is automatically focused at each point of contact, and wherein analyzing comprises:
calculating a reference line based on the data generated, and for each data point, subtracting the reference value from the data value, to generate a final value for each data point, and optionally further comprising determining the surface roughness from the final values, wherein the method is optionally automated.

17. A method for monitoring the surface roughness of a sputtering target assembly during production, comprising:
periodically determining surface roughness of sputtering target assembly or portion thereof according to the method of claim 10, to generate a surface roughness value;
adapting production based on the roughness value, wherein periodically determining optionally comprises determining sputtering target surface roughness one or more times, and wherein periodically determining and adapting, are optionally automated.
